(19) United States
(12) Patent Application Publication
(10) Pub. No.: US 2003/0072365 A1
(43) Pub. Date: Apr. 17, 2003

(54) MPEG conversion system for converting digital video signals, MPEG conversion apparatus and recording medium memorizing a software of the MPEG conversion system

(75) Inventor: Koh Hiratsuka, Inzai-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Nagase & Co., Ltd, Osaka (JP)

(21) Appl. No.: 10/236,189

(22) Filed: Sep. 6, 2002

Related U.S. Application Data
(63) Continuation-in-part of application No. 10/044,227, filed on Jan. 10, 2002.

(30) Foreign Application Priority Data
Apr. 8, 2002 (JP) 2002-104694
Mar. 1, 2001 (JP) 56625/2001

(51) Int. Cl. H04N 7/12

(52) U.S. Cl. 375/240.03

(57) ABSTRACT

An MPEG conversion system for converting digital video signals transferred from a digital video camera to a personal computer into MPEG data and saving into a data storage apparatus is disclosed. When an intermediate working area for the conversion is entirely occupied, the camera is stopped. After the position of the tape at this time is read and memorized, the tape is rewound to a prescribed position. When the working area has a vacancy, the camera is started and, when the tape exactly reaches the memorized position, the writing of the digital video signals into the working area is resumed. The digital video signals are then converted into MPEG data. Images of a high quality are produced without frame drops or excessive occupation of the disk space even when a low speed personal computer is used. MPEG data can be obtained automatically by leaving the apparatus standing without manipulation for a prescribed time.

This application is a continuation-in-part application of application Ser. No. 10/044,227, filed Jan. 10, 2002.

### BACKGROUND OF THE INVENTION

1. Field of the Invention

The present invention relates to an MPEG conversion system for converting digital video signals, an MPEG conversion apparatus and a recording medium memorizing a software of the MPEG conversion system. More particularly, the present invention relates to an MPEG conversion system for converting digital video signals which performs the conversion into MPEG data without frame drops by controlling the operation of the digital video camera even when a low speed personal computer is used, to an MPEG conversion apparatus and to a recording medium memorizing the software of the MPEG conversion system.

2. Description of Related Art

Data of moving images such as data of digital video cameras contain a great amount of information. Therefore, a recording medium having an extremely great capacity is required to read the data of moving images and record the data into a recording medium such as a personal computer. Since only limited types of personal computers can use the recording medium having an extremely great capacity in the present situation, it is widely conducted that the original data signals are compressed so that the area of the recording medium used for recording the data signals is decreased. The MPEG2 system which is used in commercial DVD video discs is one of the signal compression systems.

To create MPEG data from images and sounds of a digital video camera by using a software, the following procedures are heretofore conducted. The digital video camera and a personal computer are connected to each other via an IEEE 1394 interface. The digital data can be converted into MPEG data in accordance with one of the following two methods. In one method, the entire digital data are temporarily saved into a hard disk or the like other data storage apparatus in accordance with the DV codec and the saved data are converted into MPEG data using a batch type software for conversion of AVI to MPEG1, 2 or 4 (the AVI-to-MPEG encoder). In the other method, the data coming from the digital video camera are converted into MPEG1, 2 or 4 by the real-time conversion using a high speed personal computer and the converted data are written into a hard disk or the like other data storage apparatus while the conversion is conducted (the real time encoder).

In the case of the AVI-to-MPEG encoder, when the data of a digital video camera is saved into a personal computer as an AVI file in accordance with the DV codec system (a compression system) of the digital video camera, a recording medium of 2 GB can contain data of as short as 9 minutes. Therefore, a capacity of about 25 to 27 GB is required to save video data of 2 hours. To save the data of images of a long time as the AVI data in accordance with the DV codec, it is absolutely necessary that a personal computer equipped with a hard disk having a sufficient capacity be used.

When an MPEG file is directly created by the real time encoder, a high speed CPU is necessary and conventional personal computers and laptop type personal computers cannot exhibit the necessary speed of the treatment. Therefore, a problem arises in that frame drops are found or the quality of the images markedly deteriorates unless a huge hard disk is used. As described above, heretofore, the single possible method to overcome the problem in the MPEG conversion and, in particular, the MPEG2 conversion of video data such as data of a digital video camera has been to make a huge area of a hard disk available for the use.

Previously, the present inventor developed an apparatus for MPEG conversion which converts digital video signals transferred from a digital video camera to a personal computer into MPEG data and saves converted data into a data storage apparatus. In the conversion treated by the apparatus, the transferred digital video signals are temporarily saved into a working area or, when the conversion cannot keep up with the transfer of the digital video signals, a portion of the digital video signals or intermediate data thereof which cannot be processed by a real-time conversion into MPEG data is temporarily saved into the working area while the conversion is conducted and the digital video signals or intermediate data thereof temporarily saved into the working area are converted into MPEG data and then saved into the data storage apparatus. To perform the above conversion, the apparatus for MPEG conversion comprises a means for stopping transfer of the digital video signals by sending a command to the digital video camera when the capacity of the working area is entirely occupied and a means for starting transfer of the digital video signals by sending a command to the digital video camera when a vacancy is found in the capacity of the working area. However, it has been found by further studies by the present inventor that, even when the above apparatus is used, the tape overruns due to the inertia of the tape and it is difficult to completely eliminate formation of blank portions and frame drops in the recorded data.

A phenomenon similar to the above which is called the buffer underrun error may take place. In this case, when data are transferred and saved into a recording medium such as CD-R, the transfer of the data is interrupted during the transfer. This phenomenon is a serious problem when data are continuously saved into a recording medium in a personal computer.

For example, in Japanese Patent Application Laid-Open No. 2000-40302, a recording apparatus used for recording input data such as data from a compact disc (CD) into CD-R (a recording medium of the write-once type) via a personal computer is disclosed. This apparatus comprises: a means for controlling recording which controls recording of the data into the disc in accordance with the estimation on the possibility of occurrence of the buffer underrun; a means for detecting the position of starting recording which records the position at the top of the vacant area of the disc where no data are recorded and detects the position of starting recording the data by using the means for controlling recording; and means for connecting signals which continuously connects the data newly recorded in the disc with the data already recorded in the disc. When it is estimated that the buffer underrun may take place, recording the data into the disc is temporarily stopped by the means for controlling recording. When it is estimated that the buffer underrun will not take place, the data newly recorded into the disc is continuously connected with the data already recorded in the disc by the means for connecting signals. The new data which are to be continuously connected with the data already recorded in the disc before the temporary stopping of the recording are written into the position detected by the means for detecting the position of starting recording.

In contrast, in accordance with the present invention, members of the system are operated in a manner opposite to the above technology. The apparatus (the digital video camera) is temporarily stopped when the buffer is entirely occupied and the apparatus (the digital video camera) is operated (moving images are obtained from the apparatus) when a vacancy is found in the buffer. The operation may appear similar but, in fact, the concept of the operation is just opposite. No references relating to the present invention can be found in the field of the video camera as far as the present inventor knows.

### SUMMARY OF THE INVENTION

The present invention has an object of providing an MPEG conversion apparatus which can convert transferred digital video signals into MPEG data, produce images of a high quality without frame drops or excessive occupation of the disk space even when a low speed personal computer is used and provide MPEG data automatically by leaving the apparatus standing without manipulation for a prescribed time.

As the result of extensive studies by the present inventor to achieve the above object, it was found that images of a high quality were produced without frame drops or excessive occupation of the disk space even when a low speed personal computer was used when the following system was used. When, in conversion of digital video signals transferred from a digital video camera to a personal computer into MPEG data and saving of the converted data into a data storage apparatus, the digital video signals transferred from the digital video camera to a personal computer were temporarily saved into a working area or, when the conversion could not keep up with the transfer of the digital video signals, a portion of the digital video signals or intermediate data thereof which could not be processed by the real-time conversion into MPEG data was temporarily saved into the working area while the conversion was conducted and the digital video signals or intermediate data thereof temporarily saved into the working area were converted into MPEG data and then saved into the data storage apparatus, the system sent a command to the digital camera to temporarily stop generation of the digital video signals when a capacity of the working area is entirely occupied, and sent a command to the digital camera to resume the generation of the digital video signals when a vacancy is found in the capacity of the working area. When the digital video signals transferred from the digital video camera were temporarily saved into the working area and the digital video signals saved into the working area were converted into MPEG data, the system further read the position of the tape at the time of the stopping from a time code of the tape and memorized this position when the capacity of the working area was entirely occupied, sent a command to the digital camera to stop the digital video camera; excessively rewound the tape to a position of the tape decided in advance and stopped the tape at this position; resumed generation of the digital video signals when a vacancy was found in the capacity of the working area; and sent a command to resume saving the digital video signals into the working area when the tape exactly reached the memorized position of the tape at the time of the stopping.

The present invention provides:

(1) An MPEG conversion system for converting digital video signals transferred from a digital video camera to a personal computer into MPEG data and saving the converted data into a data storage apparatus, wherein the digital video signals transferred from the digital video camera are temporarily saved into a working area or, when the conversion cannot keep up with the transfer of the digital video signals, a portion of the digital video signals or intermediate data thereof which cannot be processed by a real-time conversion into MPEG data is temporarily saved into the working area while the conversion is conducted and the digital video signals or intermediate data thereof temporarily saved into the working area are converted into MPEG data and then saved into the data storage apparatus, the MPEG conversion system comprising:

sending a command to the digital video camera to temporarily stop generation of the digital video signals when a capacity of the working area is entirely occupied, and

sending a command to the digital video camera to resume the generation of the digital video signals when a vacancy is found in the capacity of the working area;

(2) A system described in (1), which further comprises:

when the capacity of the working area is entirely occupied, sending a command to the digital video camera to stop the digital video camera, reading a position of a tape at a time of the stopping from a time code of the tape and memorizing said position,

excessively rewinding the tape to a position of the tape decided in advance and stopping the tape at said position,

when a vacancy is found in the capacity of the working area, resuming generation of the digital video signals, and

when the tape exactly reaches the memorized position of the tape at the time of the stopping, sending a command to resume saving the digital video signals into the working area;

(3) An MPEG conversion apparatus for converting digital signals transferred from a digital video camera to a personal computer into MPEG data and saving the converted data into a data storage apparatus, wherein the digital video signals transferred from the digital video camera are temporarily saved into a working area or, when the conversion cannot keep up with the transfer of the digital video signals, a portion of the digital video signals or intermediate data thereof which cannot be processed by a real-time conversion into MPEG data is temporarily saved into the working area while the conversion is conducted and the digital video signals or intermediate data thereof temporarily saved into the working area are converted into MPEG data and then saved into the data storage apparatus, the MPEG conversion apparatus comprising:

a means for sending a command to the digital video camera to stop generation of the digital video signals when the capacity of the working area is entirely occupied,

a means for sending a command to the digital video camera to resume generation of the digital video signals when a vacancy is found in the capacity of the working area,

a means for reading a position of a tape,

a means for rewinding the tape, and

a means for resuming generation of the digital video signals after the tape is excessively rewound to a position of the tape decided in advance and resuming saving the digital video signals into the working area when a position of the tape generating the digital video signals exactly agrees with a position of the tape at a time when generation of the digital video signals is stopped;

(4) A recording medium which memorizes the MPEG conversion system for converting digital video signals described in (1); and

(5) A recording medium which memorizes the MPEG conversion system for converting digital video signals described in (2).

The preferable embodiments of the present invention include:

(6) A system described in (1), wherein the working area is formed on a hard disk; and

(7) A system described in (2), wherein the working area is formed on a main memory.

### BRIEF DESCRIPTION OF THE DRAWINGS

FIG. 1 shows a block diagram exhibiting an embodiment of the present invention.

FIG. 2 shows a diagram exhibiting the relation between the condition of a buffer and the operation of a digital video camera.

FIG. 3 shows a schematic diagram exhibiting the change in the speed of a tape.

FIG. 4 shows a flow diagram exhibiting the buffer treatment in the present invention.

The numbers in the figures have the following meanings:

1: A digital video camera

2: An IEEE 1394 interface

3: A personal computer

4: An image obtaining unit

5: A buffer area

6: An MPEG converter

7: A hard disk unit

8: A buffer monitor

9: A camera control unit

### DESCRIPTION OF THE PREFERRED EMBODIMENTS

The present invention provides the system used for converting digital video signals transferred from a digital video camera to a personal computer into MPEG data and writing the converted data into a data storage apparatus, an MPEG conversion apparatus using the system and a recording medium memorizing the software of the system. The data storage apparatus used for the apparatus of the present invention is not particularly limited. Examples of the apparatus include IC memories, hard disks, CD-R, CD-RW, DVD-RAM, DVD-R, DVD-RW, DVD+RW, +R floppy disks and high density floppy disks which are disposed in the computer or outside the computer. The MPEG system used in the present invention is not particularly limited. Any of MPEG1, MPEG2 and MPEG4 can be used.

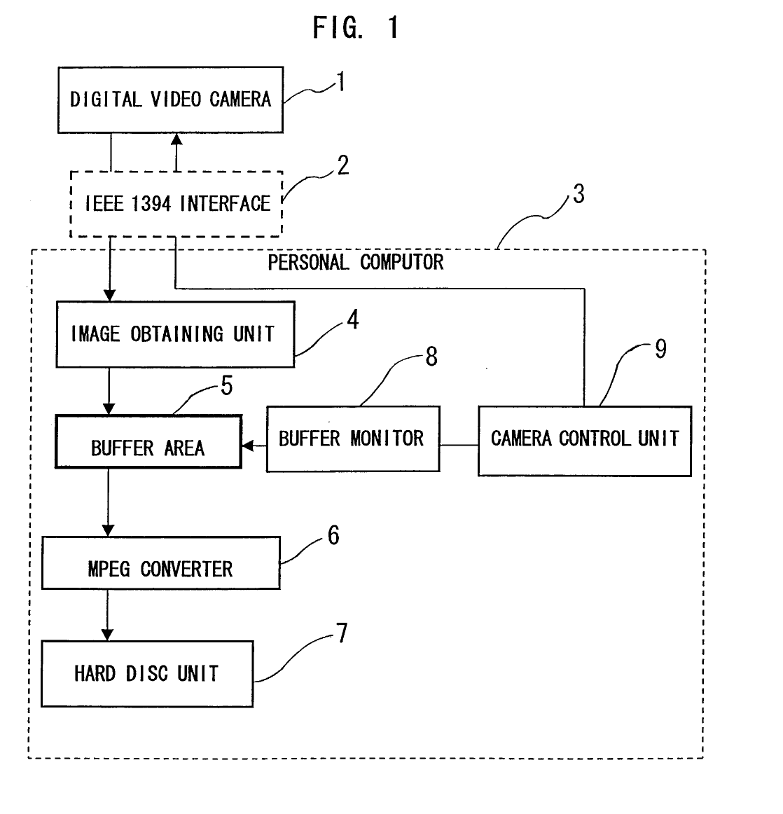

FIG. 1 shows a block diagram exhibiting an embodiment of the present invention. A personal computer 3 connected with a digital video camera 1 via an IEEE 1394 interface 2 is used. From a camera control unit 9 in the personal computer, a command to generate the data of the digital video data is sent to the digital video camera 1 via the IEEE 1394 interface 2 and images are transferred via the IEEE 1394 interface 2.

The images transferred via an image obtaining unit 4 are saved into a buffer area 5 in the form of an AVI file or intermediate data, converted into MPEG data by an MPEG converter 6 and then written into a hard disk in a hard disk unit 7. When the MPEG conversion cannot keep up with the transfer of the data, overflowing data are kept into the buffer area 5.

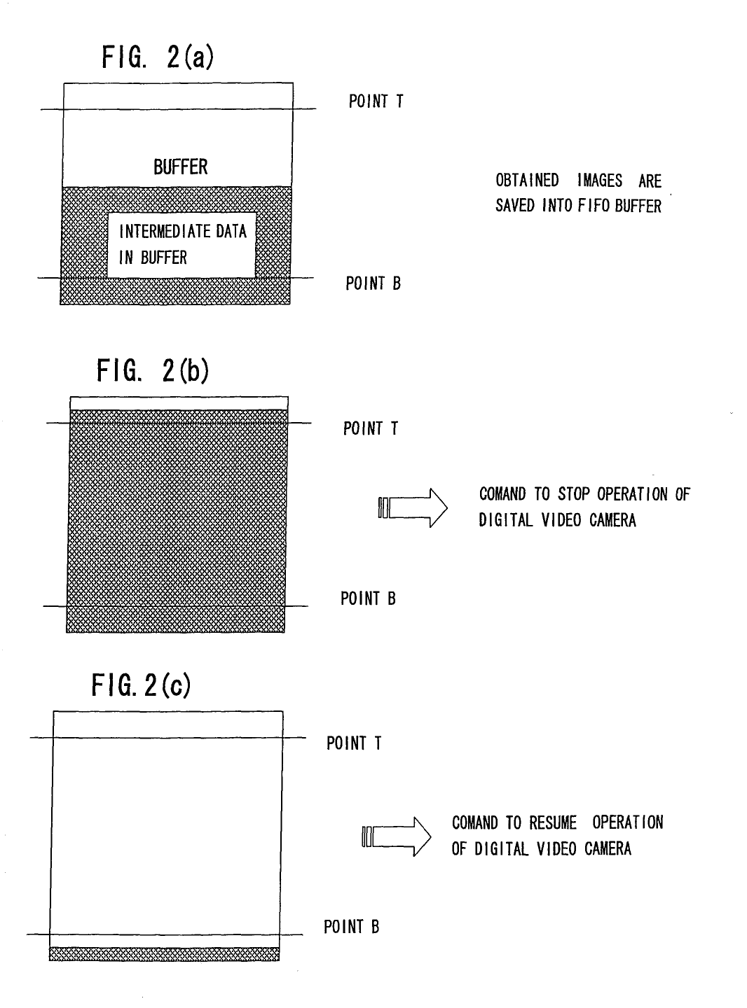

FIG. 2 shows a diagram exhibiting the relation between the amount of data in the buffer and the command of operation to the digital video camera in accordance with the amount of data in the buffer area. FIG. 2(a) shows the condition in which data of images and sound obtained from the digital video camera are stored in a FIFO buffer in the form of intermediate data. FIG. 2(b) shows the condition in which a command is sent to stop the digital video camera. FIG. 2(c) shows the condition in which the command is sent to resume the operation of the digital video camera.

In FIG. 2, the shaded portion shows the portion occupied with the intermediate data. The intermediate data are always monitored by the buffer monitor 8 shown in FIG. 1. When the amount of the data in the buffer exceeds a prescribed value (point T in FIG. 2), a command is sent from the camera control unit 9 shown in FIG. 1 via the IEEE 1394 interface to perform the following operations: the digital video camera 1 is stopped; at the same time, the position of the tape at this time is read from the time code of the tape by a means for reading the position of the tape of the digital video camera and memorized; and the tape is excessively rewound to a position decided in advance and then stopped. Thus, the generation of the digital video signals and the operation of a means for winding the video tape are stopped.

When it is confirmed by the buffer monitor 8 that, after the camera has been stopped, the amount of the data in the buffer has decreased and reached point B in FIG. 2, a command is sent from the camera control unit 9 to the digital camera 1 via the IEEE 1394 interface 2 so that the generation of the digital video signals is resumed. At the moment when it is confirmed by the means for reading the position of the tape in the digital video camera 1 that the time code of the tape exactly agrees with the time code of the tape read and memorized at the time of stopping the signals in the previous run, a command is sent to the unit for obtaining images in the personal computer 3 and the acquisition of the images is resumed. In this manner, the operations of reading, stopping, rewinding, stopping, starting generation of images, reading and so on are repeated and the control is made so that the images are connected as continuous data by controlling the time code.

The present invention will be described more specifically in the following.

As described in the above embodiment, when the working area is formed on the hard disk, an area for temporarily saving an AVI file (or an intermediate file) is assigned by the program and an automatic operation or a manual operation is decided by the user or the program. The transferred DV data are stored in this area. When the area is entirely occupied, a command is sent to the digital video camera via the IEEE 1394 interface so that the generation of the digital video signals is stopped and, at the same time, the position of the tape is read by the apparatus for reading the position of the tape and memorized. A command is sent to the means for rewinding the tape so that the tape is rewound to a position decided in advance and is prepared for resuming the generate of signals in the tape and the tape is rewound and stopped.

The AVI file or the intermediate data file in the hard disk is converted into MPEG1, MPEG2 or MPEG4 using the MPEG conversion software and saved into another area and file 1 is created. It is not always necessary that the operation of the conversion into MPEG is conducted after the AVI file or the intermediate data file has been stored into the area. The conversion may also be conducted while the AVI file or the intermediate data file is being saved into the area. In the above embodiment, the tape is rewound immediately after the generation of signals in the tape is stopped. However, the tape may be temporarily stopped when the generate of signals in the tape is stopped and the tape may be rewound immediately before resuming the generate of signals in the tape.

The condition in which the data from the digital video camera can be saved into the buffer is detected by monitoring the buffer. When it is detected that the prescribed condition is satisfied, the command to resume the digital video camera is sent via the IEEE 1394 interface and generation of the digital video signal is resumed. When the video tape exactly reaches the position memorized at the time when the digital video signals stopped in the previous run, the saving of the digital video signals of the images from the digital video camera is resumed. The saved signals are overwritten into the area into which the AVI files or the intermediate data files have been saved in the runs conducted before and the succeeding AVI file or intermediate data file is written continuously to the file in the preceding run.

The position decided in advance in the rewinding of the tape is a position reached by a necessary amount of rewinding from the position of the stopping. The necessary amount of rewinding of the tape is the amount of rewinding such that, when the tape is wound and the saving of the digital video data is resumed at the position of stopping of the tape (the memorized position of the time code), the speed of the tape is kept sufficiently constant at the position of resuming saving the digital video data (the position of stopping in the preceding run).

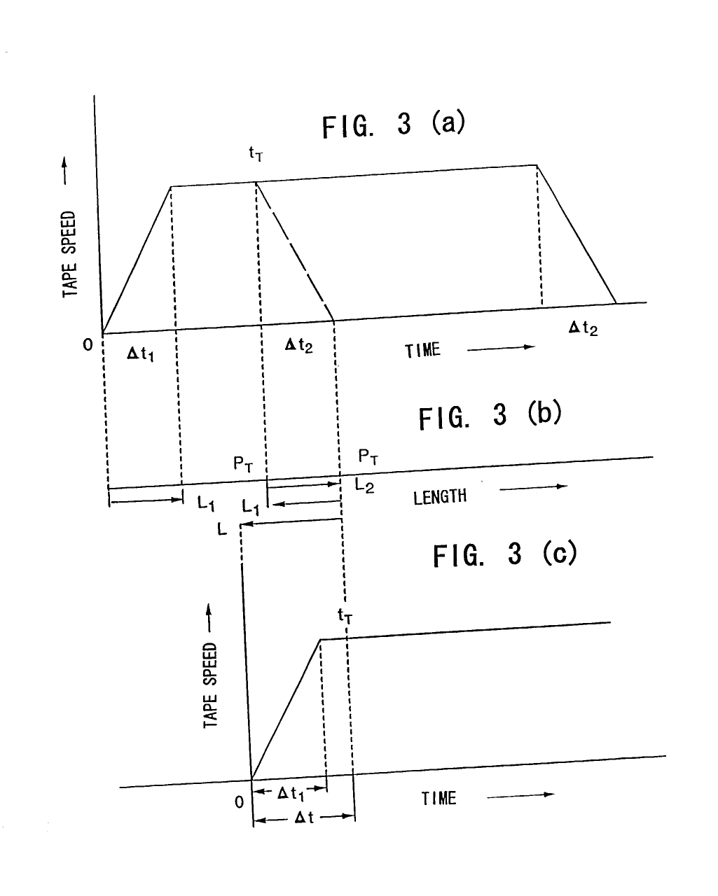

FIG. 3 shows a schematic diagram exhibiting the change in the speed of the tape. FIG. 3(a) shows a schematic diagram exhibiting the change of the speed of the video tape with time and FIG. 3(b) shows positions in the video tape corresponding to FIG. 3(a). The ordinate in FIG. 3(a) shows the speed of the tape and the abscissa shows the time. As shown in FIG. 3(a), some duration of the time (Δt₁) is necessary for the tape to reach the constant speed after the command to resume the generation of the digital video signals is sent although this duration of the time is very short and the tape runs for a distance L₁ shown in FIG. 3(b) during the time Δt₁. Some duration of time (Δt₂) is necessary also for actually stopping the video tape after the command to stop the generation of the digital video signals is sent. When it is assumed that the amount of the intermediate data reaches a point T in FIG. 2 and the command to stop transferring the digital video signals is sent at a time t_{T}, the tape actually stops after the time Δt₂. As shown in FIG. 3(b), the tape stops after running for a distance L₂ corresponding to time Δt₂ from the position of the tape P_{T} corresponding to the time t_{T} when the command to stop the generation of the digital video signals, i.e., from the position where saving of the digital video signals is stopped in the previous run. The position decided in advance in the rewinding of the video tape is decided in a manner such that the amount of the rewinding L is greater than the running distance L₁ corresponding to the time Δt₁ in FIG. 3(b).

FIG. 3(c) shows the change in the speed of the tape with time after the generation of the digital video signals is resumed. Due to the above operation, it is assured that the position of stopping saving the digital video signals P_{T} in the previous run, i.e., the position of the tape where the transfer of the digital video signals is stopped in the previous run and memorized by the means for reading the position of the tape, comes to the horizontal portion of the curve in FIG. 3(c) where the speed of the tape is kept constant. The abscises in FIG. 3(a) and FIG. 3(c) are connected to the abscissa in FIG. 3(b) with broken lines to exhibit the relation with respect to the time. However, these abscises show different amounts from each other.

In a similar manner, when the working area on the hard disk is entirely occupied, the transfer of the digital video signals form the digital video camera is stopped. The saved data are converted into the MPEG data and file 2 is added to the end of file 1.

The operations described above are repeated until the desired treatment of the DV data is completed. MPEG files such as file 2, file 3 and so on are added and the last file is created.

When the working area is formed on the main memory, the same performance as that described above can be exhibited by conducting basically the same operations as those conducted by using the hard disk.

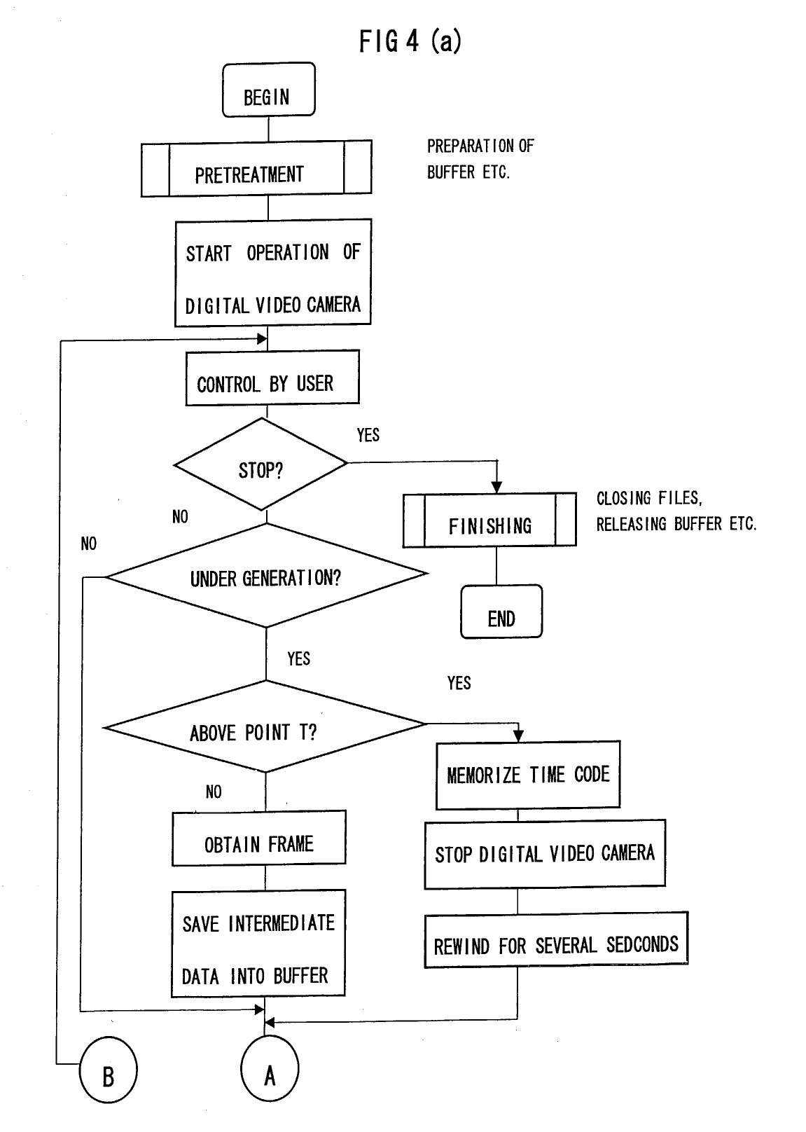

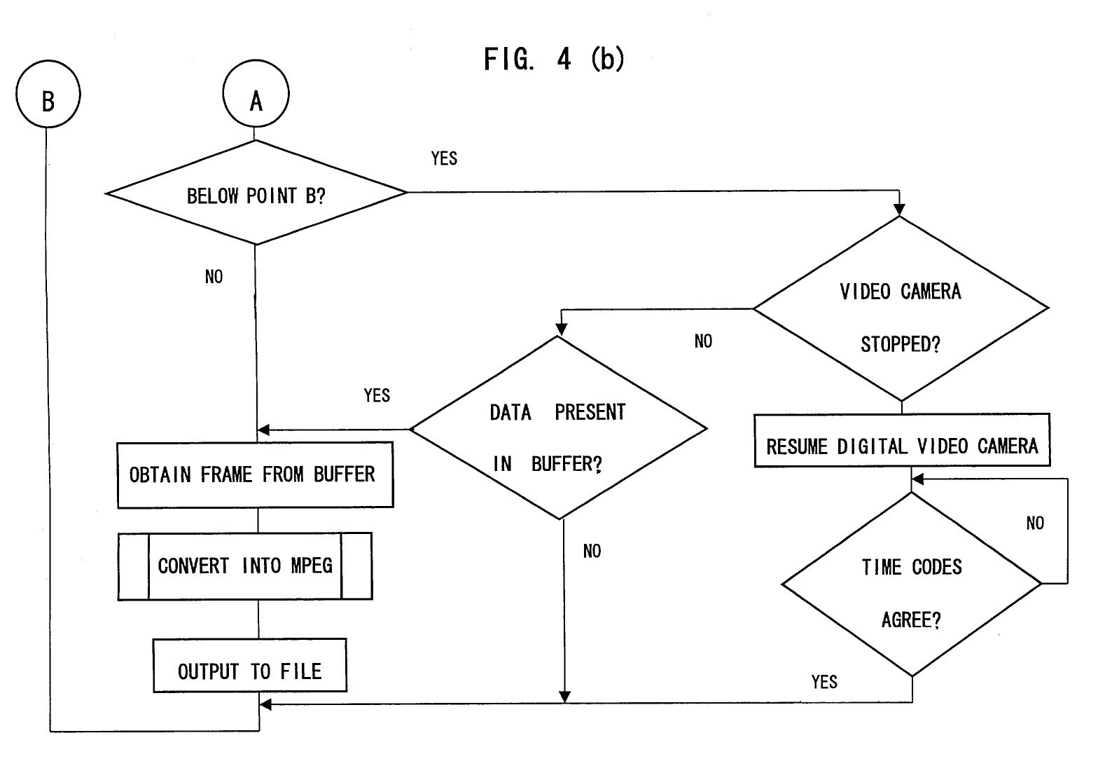

FIG. 4 which is divided into FIG. 4(a) and FIG. 4(b) shows a diagram describing an examples of the specific flow of the buffer treatment and the video camera control which can be used for present invention. The flow program may be an independent program or a portion of an application software such as an editor software for video data and an authoring software for DVD.

To summarize the advantages of the present invention, by using the MPEG conversion system and the MPEG conversion apparatus of the present invention, MPEG data of a high quality can be produced without frame drops or excessive occupation of the disk space even when a low speed personal computer is used and MPEG data are provided automatically by leaving the apparatus standing without manipulation for a prescribed time.

What is claimed is:

1. An MPEG conversion system for converting digital video signals transferred from a digital video camera to a personal computer into MPEG data and saving the converted data into a data storage apparatus, wherein the digital video signals transferred from the digital video camera are temporarily saved into a working area or, when the conversion cannot keep up with the transfer of the digital video signals, a portion of the digital video signals or a intermediate data thereof which cannot be processed by a real-time conversion into MPEG data is temporarily saved into the working area while the conversion is conducted and the digital video signals or the intermediate data thereof temporarily saved into the working area are converted into MPEG data and then saved into the data storage apparatus, the MPEG conversion system comprising:
sending a command to the digital video camera to temporarily stop generation of the digital video signals when a capacity of the working area is entirely occupied, and
sending a command to the digital video camera to resume the generation of the digital video signals when a vacancy is found in the capacity of the working area.

2. A system according to claim 1, which further comprises:
when the capacity of the working area is entirely occupied, sending a command to the digital video camera to stop the digital video camera, reading a position of a tape at a time of the stopping from a time code of the tape and memorizing said position,
excessively rewinding the tape to a position of the tape decided in advance and stopping the tape at said position,
when a vacancy is found in the capacity of the working area, resuming generation of the digital video signals, and
when the tape exactly reaches the memorized position of the tape at the time of the stopping, sending a command to resume saving the digital video signals into the working area.

3. An MPEG conversion apparatus for converting digital video signals transferred from a digital video camera to a personal computer into MPEG data and saving the converted data into a data storage apparatus, wherein the digital video signals transferred from the digital video camera are temporarily saved into a working area or, when the conversion cannot keep up with the transfer of the digital video signals, a portion of the digital video signals or a intermediate data thereof which cannot be processed by a real-time conversion into MPEG data is temporarily saved into the working area while the conversion is conducted and the digital video signals or the intermediate data thereof temporarily saved into the working area are converted into MPEG data and then saved into the data storage apparatus, the MPEG conversion apparatus comprising:
a means for sending a command to the digital camera to stop generation of the digital video signals when the capacity of the working area is entirely occupied,
a means for sending a command to the digital camera to resume generation of the digital video signals when a vacancy is found in the capacity of the working area,
a means for reading a position of a tape,
a means for rewinding the tape, and
a means for resuming generation of the digital video signals after the tape is excessively rewound to a position of the tape decided in advance and resuming saving the digital video signals into the working area when a position of the tape generating the digital video signals exactly agrees with a position of the tape at a time when generation of the digital video signals is stopped.

4. A recording medium which memorizes the MPEG conversion system for converting digital video signals described in claim 1.

5. A recording medium which memorizes the MPEG conversion system for converting digital video signals described in claim 2.
